(19) United States
(12) Patent Application Publication
(10) Pub. No.: US 2026/0339328 A1
(43) Pub. Date: Oct. 29, 2026

(54) Control Guidance Method, Device and Computer-readable Storage Medium for Aerial Vehicle

(71) Applicant: EHANG INTELLIGENT EQUIPMENT (GUANGZHOU) CO., LTD., Guangzhou, Guangdong (CN)

(72) Inventors: Huazhi Hu, Guangzhou, Guangdong (CN); Yong Liu, Guangzhou, Guangdong (CN); Haisheng Hu, Guangzhou, Guangdong (CN); Xingjie Lu, Guangzhou, Guangdong (CN)

(21) Appl. No.: 19/107,017

(22) PCT Filed: Aug. 9, 2023
(86) PCT No.: PCT/CN2023/111856

§ 371 Date: Feb. 26, 2025

(30) Foreign Application Priority Data
Aug. 31, 2022 (CN) 202211052466.7

(51) Int. Cl. G05D 1/495; G05D 109/25

(52) U.S. Cl. CPC G05D 1/495; G05D 2109/254

(57) ABSTRACT

A control guidance method, device and computer-readable storage medium for an aerial vehicle is disclosed. The method includes: calculating a horizontal acceleration target and a vertical acceleration target according to a three-dimensional velocity target, a three-dimensional velocity feedforward instruction and three-dimensional velocity observation data; calculating a horizontal attitude target according to the horizontal acceleration target and the horizontal acceleration observation data, and calculating the average rotational velocity by the vertical acceleration target, the vertical acceleration observation data and the angle observation data; calculating a three-axis rotational velocity difference according to the horizontal attitude target, the angle observation data, the yaw angle target and the angular velocity observation data, and calculating the rotational velocity instruction of each motor of the aerial vehicle according to the average rotational velocity and the three-axis rotational velocity difference.

### TECHNICAL FIELD

The present disclosure relates to the technical field of unmanned aerial vehicles, and in particular to a control guidance method, device and computer-readable storage medium for aerial vehicle.

### BACKGROUND TECHNOLOGY

In the prior art, with the rapid development of public air transportation, taking an airplane to achieve fast and comfortable travel has become an extremely common mode of transportation in people's daily lives. Compared with traditional manned aerial vehicle, unmanned aerial vehicle can achieve safer, environmentally friendly and intelligent low-altitude short-distance manned transportation.

At present, when navigating, unmanned aerial vehicle need to provide real-time observation information, such as three-dimensional angle information, three-dimensional angular velocity information, three-dimensional position information, three-dimensional velocity information and three-dimensional acceleration information.

How to effectively perform the attitude and velocity control of the aerial vehicle according to the above real-time observation information to achieve stable flight and tracking guidance of the unmanned aerial vehicle has become a technical problem that needs to be solved urgently.

### SUMMARY

### Technical Issue

In view of this, the present disclosure proposes a control guidance method, device and computer-readable storage medium for aerial vehicle to solve the problem that the attitude and velocity control of the aerial vehicle cannot be effectively performed according to the real-time observation information to achieve stable flight and tracking guidance of the unmanned aerial vehicle.

### Technical Solution

The present disclosure proposes a control guidance method for an aerial vehicle, the method including:
inputting a three-dimensional velocity target, a three-dimensional velocity feedforward instruction and three-dimensional velocity observation data into a velocity controller of the aerial vehicle, and calculating a horizontal acceleration target and a vertical acceleration target, wherein the three-dimensional velocity target is calculated by a position controller of the aerial vehicle according to a received three-dimensional position instruction and three-dimensional position observation data;
inputting the horizontal acceleration target and horizontal acceleration observation data into a horizontal acceleration controller of the aerial vehicle, and calculating a horizontal attitude target, and inputting the vertical acceleration target, vertical acceleration observation data and angle observation data into a vertical acceleration controller of the aerial vehicle, and calculating an average rotational velocity;
inputting the horizontal attitude target, the angle observation data, a yaw angle target and an angular velocity observation data into an attitude controller of the aerial vehicle, and calculating a three-axis rotational velocity difference, and inputting the average rotational velocity and the three-axis rotational velocity difference into a power distribution module of the aerial vehicle, and calculating a rotational velocity instruction of each motor of the aerial vehicle.

The present disclosure also proposes a control guidance device for an aerial vehicle, including a memory, a processor and a computer program stored in the memory and executable on the processor, the computer program implements the steps of the above control guidance method for an aerial vehicle when executed by the processor.

The present disclosure also proposes a computer-readable storage medium having a control guidance program for an aerial vehicle stored thereon, the control guidance program for the aerial vehicle implements the steps of the above control guidance method for an aerial vehicle when executed by the processor.

### Beneficial Effect

The control guidance method, device and computer-readable storage medium of the aerial vehicle of the embodiment of the present disclosure inputs a three-dimensional velocity target, a three-dimensional velocity feedforward instruction and three-dimensional velocity observation data into a velocity controller of the aerial vehicle, and calculates a horizontal acceleration target and a vertical acceleration target, wherein the three-dimensional velocity target is calculated by a position controller of the aerial vehicle according to a received three-dimensional position instruction and three-dimensional position observation data; inputs the horizontal acceleration target and horizontal acceleration observation data into a horizontal acceleration controller of the aerial vehicle, and calculates a horizontal attitude target, and inputs the vertical acceleration target, vertical acceleration observation data and angle observation data into a vertical acceleration controller of the aerial vehicle, and calculates an average rotational velocity; inputs the horizontal attitude target, the angle observation data, a yaw angle target and an angular velocity observation data into an attitude controller of the aerial vehicle, and calculates a three-axis rotational velocity difference, and inputs the average rotational velocity and the three-axis rotational velocity difference into a power distribution module of the aerial vehicle, and calculates a rotational velocity instruction of each motor of the aerial vehicle. The present disclosure realizes an automated aerial vehicle control guidance scheme, effectively realizes the stable flight of the aerial vehicle and the execution of guidance instructions, and greatly improves the accuracy, stability and safety of aerial vehicle flight control.

### DESCRIPTION OF THE DRAWINGS

The present disclosure will be further described below in conjunction with the drawings and embodiments, in which:

FIG. 1 is a flow chart of the first embodiment of the control guidance method of the aerial vehicle of the present disclosure.

FIG. 2 is a first flow chart of the second embodiment of the control guidance method of the aerial vehicle of the present disclosure.

FIG. 3 is a second flow chart of the second embodiment of the control guidance method of the aerial vehicle of the present disclosure.

FIG. 4 is a third flow chart of the second embodiment of the control guidance method of the aerial vehicle of the present disclosure.

FIG. 5 is a fourth flow chart of the second embodiment of the control guidance method of the aerial vehicle of the present disclosure.

FIG. 6 is a fifth flow chart of the second embodiment of the control guidance method of the aerial vehicle of the present disclosure.

FIG. 7 is a first flow chart of the third embodiment of the control guidance method of the aerial vehicle of the present disclosure.

FIG. 8 is a second flow chart of the third embodiment of the control guidance method of the aerial vehicle of the present disclosure.

FIG. 9 is a third flow chart of the third embodiment of the control guidance method of the aerial vehicle of the present disclosure.

FIG. 10 is a control logic schematic diagram of the first embodiment of the control guidance method of the aerial vehicle of the present disclosure.

FIG. 11 is a linear motion control schematic diagram of the second embodiment of the control guidance method of the aerial vehicle of the present disclosure.

FIG. 12 is a roll and pitch control schematic diagram of the second embodiment of the control guidance method of the aerial vehicle of the present disclosure.

FIG. 13 is a schematic diagram of yaw control of the second embodiment of the control guidance method for an aerial vehicle according to the present disclosure.

### IMPLEMENTATION METHOD

It should be understood that the specific embodiments described herein are only used to explain the present disclosure and are not used to limit the present disclosure.

In the subsequent description, the use of suffixes such as “module”, “component” or “unit” used to represent elements is only to facilitate the description of the present disclosure and has no specific meaning in itself. Therefore, “module”, “component” or “unit” can be used in a mixed manner.

### Embodiment 1

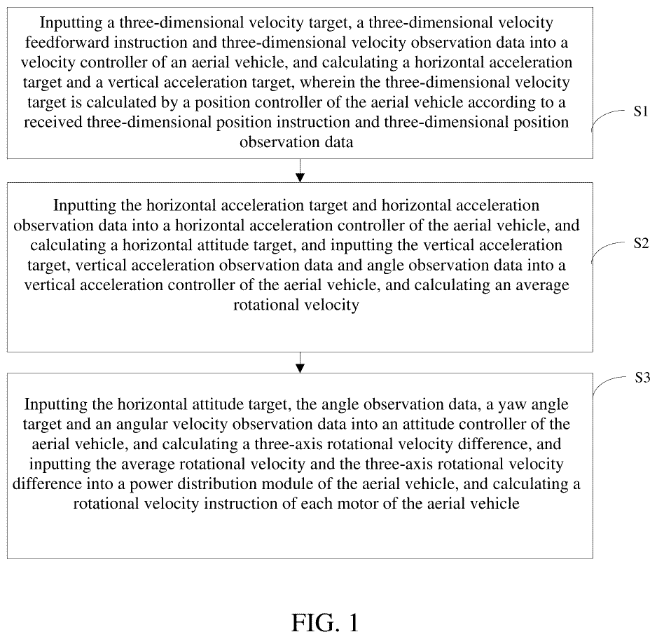

FIG. 1 is a flow chart of the first implementation method of the control guidance method for an aerial vehicle of the present disclosure. A control guidance method for an aerial vehicle, the method including:
S1, inputting a three-dimensional velocity target, a three-dimensional velocity feedforward instruction and three-dimensional velocity observation data into a velocity controller of the aerial vehicle, and calculating a horizontal acceleration target and a vertical acceleration target, wherein the three-dimensional velocity target is calculated by a position controller of the aerial vehicle according to a received three-dimensional position instruction and three-dimensional position observation data.
S2, inputting the horizontal acceleration target and horizontal acceleration observation data into a horizontal acceleration controller of the aerial vehicle, and calculating a horizontal attitude target, and inputting the vertical acceleration target, vertical acceleration observation data and angle observation data into a vertical acceleration controller of the aerial vehicle, and calculating an average rotational velocity.
S3. inputting the horizontal attitude target, the angle observation data, a yaw angle target and an angular velocity observation data into an attitude controller of the aerial vehicle, and calculating a three-axis rotational velocity difference, and inputting the average rotational velocity and the three-axis rotational velocity difference into a power distribution module of the aerial vehicle, and calculating a rotational velocity instruction of each motor of the aerial vehicle.

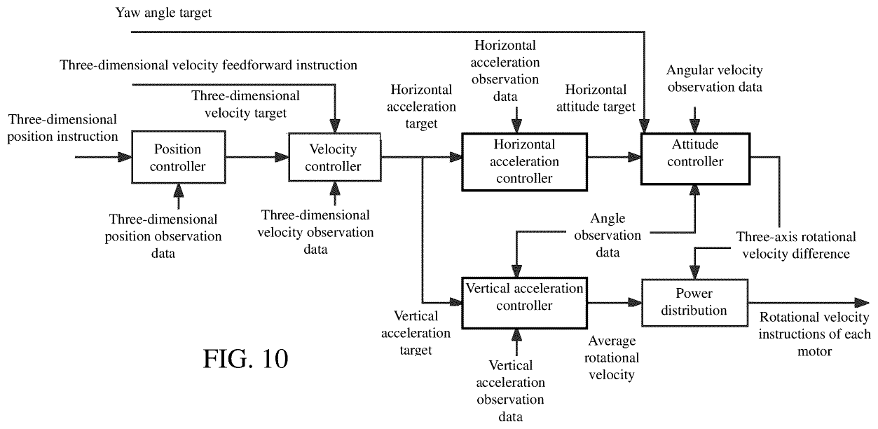

In this embodiment, the unmanned aerial vehicle includes a position controller, a velocity controller, a horizontal acceleration controller, a vertical acceleration controller, an attitude controller and a power distribution module. Specifically, please refer to the control logic diagram shown in FIG. 10, wherein the position controller is used to receive three-dimensional position instructions and three-dimensional position observation data, and calculate the three-dimensional velocity target according to the received three-dimensional position instructions and three-dimensional position observation data; the velocity controller is used to input the above-mentioned three-dimensional velocity target, and in combination with the three-dimensional velocity feedforward instructions and three-dimensional velocity observation data received externally, calculate the horizontal acceleration target and the vertical acceleration target; the horizontal acceleration controller is used to input the above-mentioned horizontal acceleration target, and in combination with the horizontal acceleration observation data received externally, calculate the horizontal attitude target; the vertical acceleration controller is used to input the above-mentioned vertical acceleration target, and in combination with the vertical acceleration observation data and angle observation data received externally, calculate the average rotational velocity; the attitude controller is used to input the above-mentioned horizontal attitude target, the set yaw angle target, and in combination with the angle observation data and angular velocity observation data received externally, calculate the three-axis rotational velocity difference; the power distribution module is used to input the above-mentioned average rotational velocity and the above-mentioned three-axis rotational velocity difference, and calculate the rotational velocity instruction of each motor of the aerial vehicle.

This embodiment implements an automated aerial vehicle control guidance solution, effectively realizes the stable flight of the aerial vehicle and the execution of guidance instructions, and greatly improves the accuracy, stability and safety of aerial vehicle flight control.

### Embodiment 2

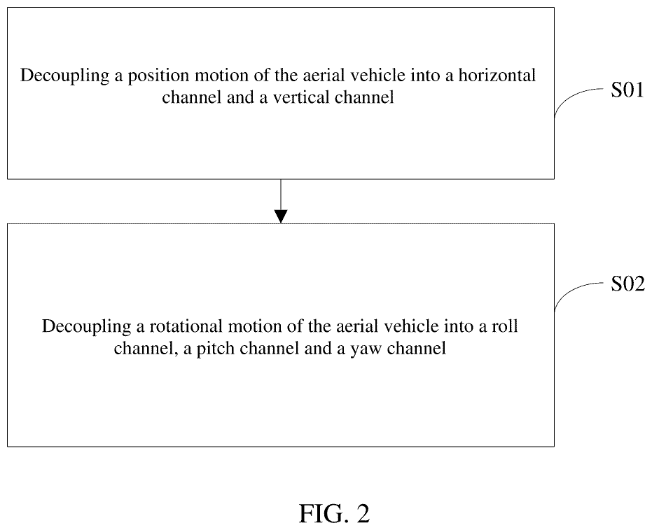

FIG. 2 is the first flow chart of the second embodiment of the control guidance method of the aerial vehicle of the present disclosure. Based on the above embodiment, before inputting the three-dimensional velocity target, the three-dimensional velocity feedforward instruction and the three-dimensional velocity observation data into the velocity controller of the aerial vehicle, and calculating the horizontal acceleration target and the vertical acceleration target, the following steps are included:
S01, decoupling a position motion of the aerial vehicle into a horizontal channel and a vertical channel.
S02, decoupling a rotational motion of the aerial vehicle into a roll channel, a pitch channel and a yaw channel.

In this embodiment, in the horizontal channel, the horizontal acceleration target and the horizontal acceleration observation data are input into the horizontal acceleration controller of the aerial vehicle, and the horizontal attitude target is calculated; in the vertical channel, the vertical acceleration target, the vertical acceleration observation data and the angle observation data are input into the vertical acceleration controller of the aerial vehicle, and the average rotational velocity is calculated.

In this embodiment, in the roll channel, pitch channel and yaw channel, the horizontal attitude target, the angle observation data, the yaw angle target and the angular velocity observation data are input into the attitude controller of the aerial vehicle, and the three-axis rotational velocity difference is calculated, and the average rotational velocity and the three-axis rotational velocity difference are input into the power distribution module of the aerial vehicle to calculate the rotational velocity instructions of each motor of the aerial vehicle.

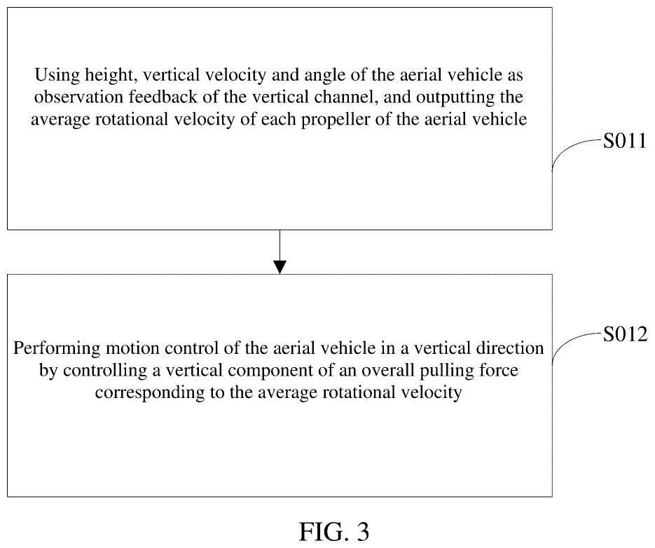

FIG. 3 is a second flow chart of the second embodiment of the control guidance method of the aerial vehicle of the present disclosure. In this embodiment, the position motion of the aerial vehicle is decoupled into a horizontal channel and a vertical channel, including the following steps:
S011, using height, vertical velocity and angle of the aerial vehicle as observation feedback of the vertical channel, and outputting the average rotational velocity of each propeller of the aerial vehicle.
S012, performing motion control of the aerial vehicle in a vertical direction by controlling a vertical component of an overall pulling force corresponding to the average rotational velocity.

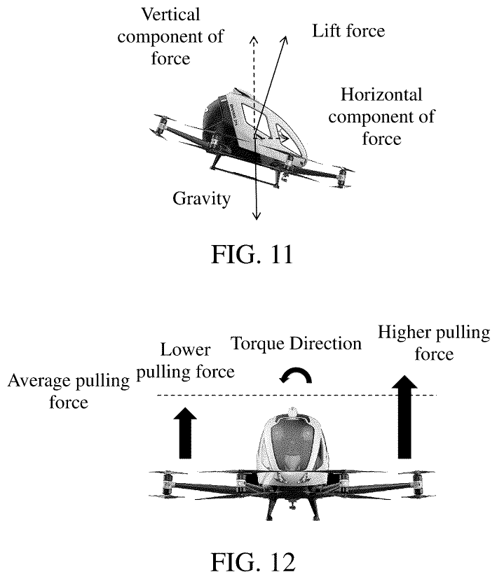

In this embodiment, please refer to the schematic diagram of the linear motion control shown in FIG. 11. In the vertical channel, the height, vertical velocity and aerial vehicle angle are used as observation feedback, and the average rotational velocity of the propeller of the aerial vehicle is output, which corresponds to the overall lifting force of the aerial vehicle.

In this embodiment, the motion control of the aerial vehicle in the vertical direction is achieved by controlling the vertical component of the overall lifting force (i.e., vertical separation).

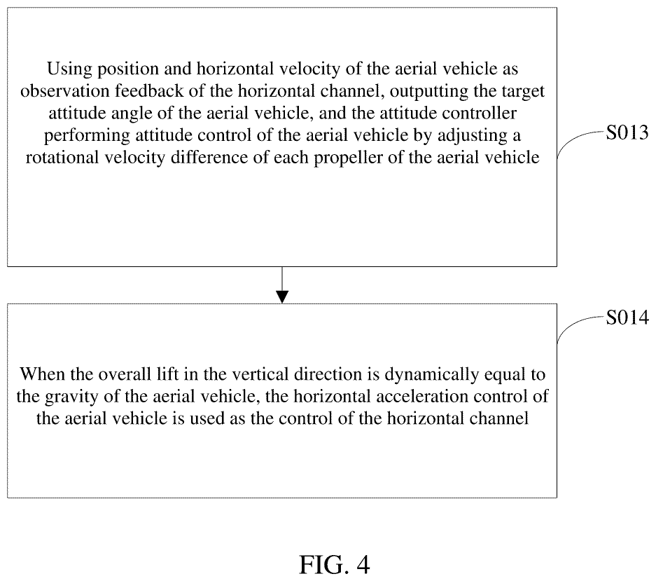

FIG. 4 is a third flow chart of the second embodiment of the control guidance method of the aerial vehicle of the present disclosure. In this embodiment, the position motion of the aerial vehicle is decoupled into a horizontal channel and a vertical channel, including the following steps:
S013, using position and horizontal velocity of the aerial vehicle as observation feedback of the horizontal channel, outputting the target attitude angle of the aerial vehicle, and the attitude controller performing attitude control of the aerial vehicle by adjusting a rotational velocity difference of each propeller of the aerial vehicle.
S014, when the overall lift in the vertical direction is dynamically equal to the gravity of the aerial vehicle, the horizontal acceleration control of the aerial vehicle is used as the control of the horizontal channel.

In this embodiment, please refer to the linear motion control schematic diagram shown in FIG. 11. In the horizontal channel, the position and horizontal velocity are used as observation feedback, and the output is the target attitude angle, and the attitude controller controls the aerial vehicle attitude through the rotational velocity difference of each propeller.

In this embodiment, the acceleration of the aerial vehicle in the horizontal direction is controlled on the basis that the overall lift (i.e., the lifting force) is dynamically equal to the gravity of the aerial vehicle in the vertical direction to complete the control of the horizontal channel.

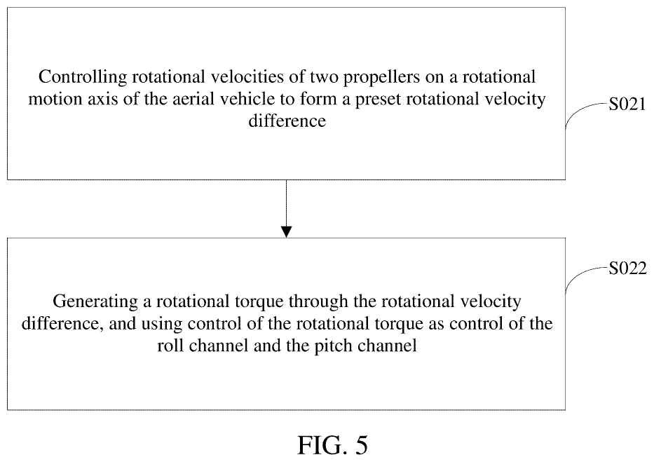

FIG. 5 is the fourth flow chart of the second embodiment of the control guidance method of the aerial vehicle of the present disclosure. In this embodiment, the rotational motion of the aerial vehicle is decoupled into a roll channel, a pitch channel, and a yaw channel, including the following steps:
S021, controlling rotational velocities of two propellers on a rotational motion axis of the aerial vehicle to form a preset rotational velocity difference.
S022, generating a rotational torque through the rotational velocity difference, and using control of the rotational torque as control of the roll channel and the pitch channel.

In this embodiment, please refer to the roll and pitch control schematic diagram shown in FIG. 12. In the roll channel and the pitch channel, the same control method of the roll motion and the pitch motion is adopted, that is, first, by controlling the rotational velocity of the two propellers on the rotational motion axis of the aerial vehicle, a preset rotational velocity difference is formed, and then, a rotational torque is generated by the rotational velocity difference, and the control of the rotational torque is used as the control of the roll channel and the pitch channel.

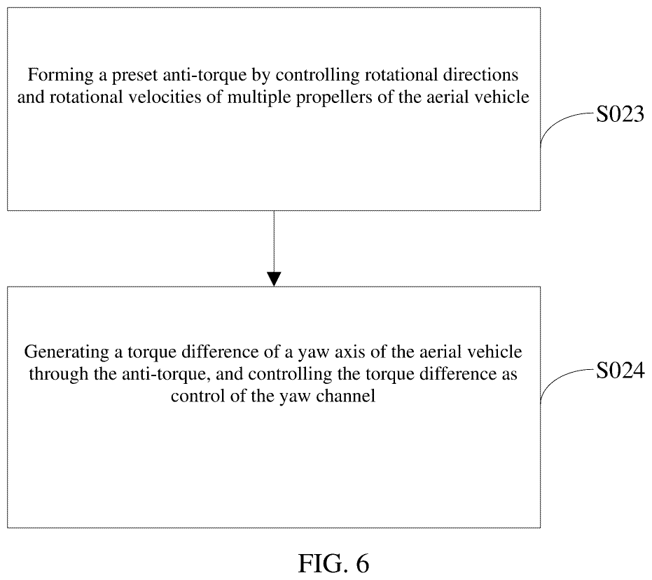

FIG. 6 is the fifth flow chart of the second embodiment of the control guidance method of the aerial vehicle of the present disclosure. In this embodiment, the rotational motion of the aerial vehicle is decoupled into a roll channel, a pitch channel and a yaw channel, including the following steps:
S023, forming a preset anti-torque by controlling rotational directions and rotational velocities of multiple propellers of the aerial vehicle.
S024, generating a torque difference of a yaw axis of the aerial vehicle through the anti-torque, and controlling the torque difference as control of the yaw channel.

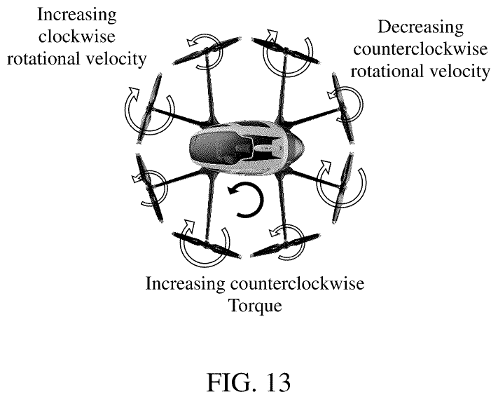

In this embodiment, please refer to the yaw control schematic diagram shown in FIG. 13. In the yaw channel, first, by controlling the rotational direction and rotational velocity of the multiple propellers of the aerial vehicle, a preset counter-torque is formed, for example, the clockwise rotational velocity of the multiple propellers is controlled to increase, and the counter-clockwise rotational velocity of the multiple propellers is controlled to decrease, so that the overall counter-clockwise torque of the aerial vehicle is increased, that is, the counter-torque is obtained; then, the torque difference of the yaw axis of the aerial vehicle is generated by the counter-torque, and the control of the torque difference is used as the control of the yaw channel.

### Embodiment 3

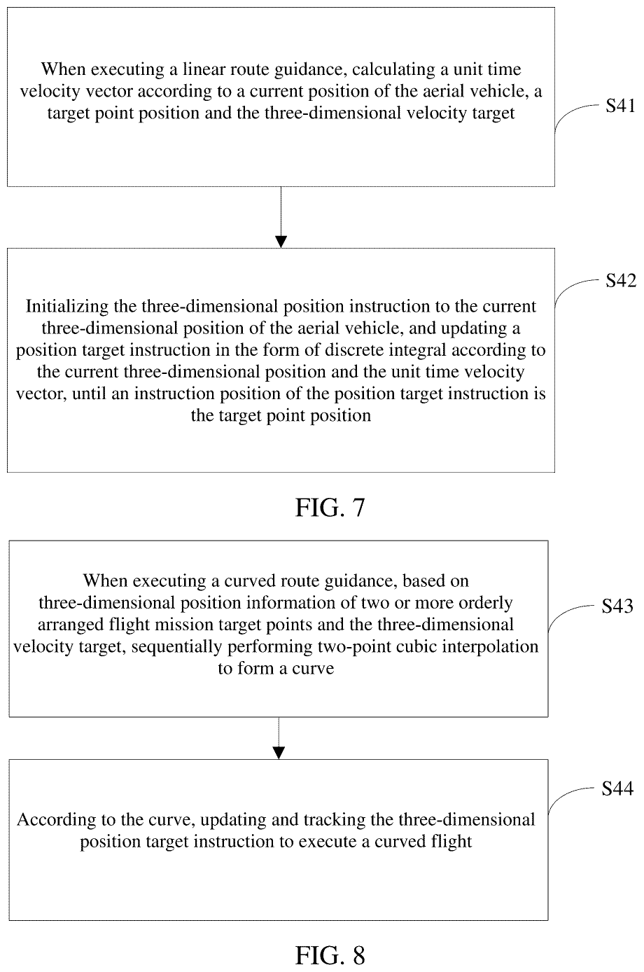

FIG. 7 is the first flow chart of the third embodiment of the control guidance method of the aerial vehicle of the present disclosure. Based on the above embodiment, in this embodiment, the following steps are included:
S41. when executing a linear route guidance, calculating a unit time velocity vector according to a current position of the aerial vehicle, a target point position and the three-dimensional velocity target.
S42. initializing the three-dimensional position instruction to the current three-dimensional position of the aerial vehicle, and updating a position target instruction in the form of discrete integral according to the current three-dimensional position and the unit time velocity vector, until an instruction position of the position target instruction is the target point position.

In this embodiment, when performing linear route guidance, a linear route from the current three-dimensional position of the aerial vehicle to the three-dimensional position of the target point is formulated according to the three-dimensional position information of the flight mission target point. Specifically, first, according to the current position O(X,Y,Z), the target point position D(X,Y,Z) and the set three-dimensional flight velocity constraint, the unit time velocity vector \vec{V}(x,y,z) is obtained; then, the advancement process of the aerial vehicle is determined, including initializing the position target instruction \vec{P}(X,Y,Z) as the current three-dimensional position of the aerial vehicle, and updating the position target instruction \vec{P}(n+1)=\vec{P}(n)+\vec{V}*Δt in the form of discrete integral according to the unit time velocity vector, until \vec{P}(n)=D; finally, the tracking process of the aerial vehicle is determined, including controlling the aerial vehicle to track the above real-time position target instruction, thereby realizing linear flight.

FIG. 8 is a second flow chart of the third embodiment of the control guidance method of the aerial vehicle of the present disclosure. In this embodiment, the following steps are included:
S43, when executing a curved route guidance, based on three-dimensional position information of two or more orderly arranged flight mission target points and the three-dimensional velocity target, sequentially performing two-point cubic interpolation to form a curve.
S44, according to the curve, updating and tracking the three-dimensional position target instruction to execute a curved flight.

In this embodiment, when executing the curved route guidance, first, the three-dimensional position information of two or more known orderly arranged flight mission target points is obtained, and according to the set constraint v̅ of the three-dimensional flight velocity, the current coordinate p₀ and the position coordinates p₁ . . . p_{N} of each point, as well as the current expected velocity vector v₀ and the expected velocity vector v₁ . . . v_{N} at each point are obtained; then, two-point cubic Hermite interpolation is performed in sequence to form a curve. Specifically, taking p₀ to p₁ as an example:

\vec{P}(t)=(2t³−3t²+1)p₀+(t³−2t²+t)v₀+(−2t³+3t²)p₁+(t³−t²)v₁, t∈(0,1);

\vec{V}(t)=(6t²−6t)p₀+(6t−4)v₀+(−6t²+6t)p₁+(3t²−2t)v₁, t∈(0,1).

After the curve is formed, the advancement process of the curved route guidance is determined, specifically including updating the position target instruction as follows:

$$\{ \begin{matrix}t ( n + 1 ) = t ( n ) + \frac{\vert \vec{V} ( t ( n ) ) \vert}{\vert \overline{v} \vert} * Δ t \\ \vec{P} ( n + 1 ) = \vec{P} ( t ( n + 1 ) )\end{matrix} .$$

In this embodiment, the position target instruction is continuously updated in the above manner until t(0)=0 to t(n)=1, similarly, the position target instruction is continued to be advanced according to the curve from p₁ to p₂ in the above manner; finally, the tracking process of the aerial vehicle is determined, that is, tracking the position target instruction, thereby realizing curved flight.

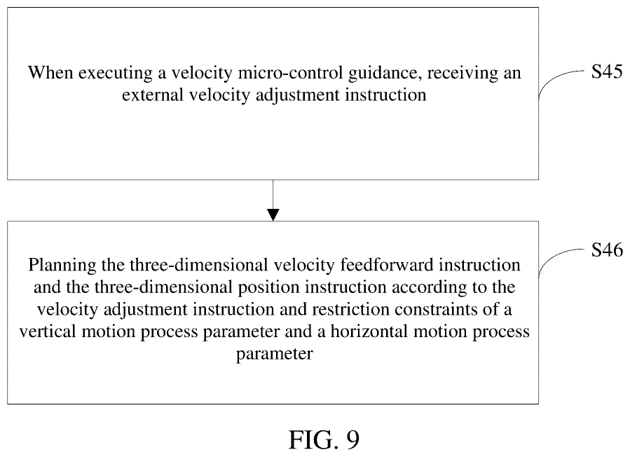

FIG. 9 is a third flow chart of the third embodiment of the control guidance method of the aerial vehicle of the present disclosure. In this embodiment, the following steps are included:
S45, when executing a velocity micro-control guidance, receiving an external velocity adjustment instruction.
S46, planning the three-dimensional velocity feedforward instruction and the three-dimensional position instruction according to the velocity adjustment instruction and restriction constraints of a vertical motion process parameter and a horizontal motion process parameter.

In this embodiment, when executing the velocity micro-control guidance, by receiving external velocity adjustment instructions and planning three-dimensional velocity feedforward instructions and three-dimensional position instructions according to the restriction constraints of motion process parameters.

In this embodiment, the transition process of the above-mentioned three-dimensional velocity feedforward instruction and three-dimensional position instruction specifically includes a vertical part and a horizontal part. Among them, for the vertical part, first, the vertical velocity instruction is limited, recorded as the upper and lower limits V_{zmax+} and V_{zmax-}; then, the vertical velocity feedforward instruction is generated, and the height position instruction is generated by integration:

$$\vec{{V}_{z}} ( n + 1 ) = \{ \begin{matrix}{V}_{zinput} ( n + 1 ) \\ s . t . {V}_{zmax -} \leq {V}_{zinput} ( n + 1 ) \leq {V}_{zmax +}\end{matrix} ;$$

\vec{P_{z}}(n+1)=\vec{P_{z}}(n)+\vec{V_{z}}(n+1)*Δt.

In this embodiment, for the horizontal part, first, considering that the motion response of the horizontal part is not as fast as that of the vertical part, a smoother low-bandwidth process needs to be configured; then, for the input horizontal velocity instructions V_{xyinput}(n), the inertia link is configured through the maximum horizontal acceleration limit a_{XYmax} and the maximum horizontal velocity limit v_{XYmax} to obtain the horizontal velocity feedforward instructions, and the horizontal position instruction is generated by integration:

$$\vec{{a}_{xy}} ( n + 1 ) = \frac{{V}_{xyinput} ( n + 1 ) - \vec{{V}_{xy}} ( n )}{Δ t} ;$$

$$\vec{{V}_{xy}} ( n + 1 ) = \{ \begin{matrix}\vec{{V}_{xy}} ( n ) + ( \vec{{a}_{xy}} ( n + 1 ) - \frac{\vec{{V}_{xy}} ( n )}{{v}_{XYmax}} * {v}_{XYmax} ) * Δ t \\ s . t . - {a}_{XYmax} \leq \vec{{a}_{xy}} ( n + 1 ) \leq {a}_{XYmax}\end{matrix} ;$$

\vec{P_{xy}}(n+1)=\vec{P_{xy}}(n)+\vec{V_{xy}}(n+1)*Δt.

It can be seen that in this embodiment, based on the real-time observation information provided by navigation, including three-dimensional angle information, three-dimensional angular velocity information, three-dimensional position information, three-dimensional velocity information and three-dimensional acceleration information, the attitude and velocity of the aerial vehicle are changed by controlling the actuator of the aerial vehicle, so as to achieve stable flight and tracking the execution of guidance instructions. At the same time, in the guidance process, according to the information such as the position and velocity of the target, and according to its own position, velocity and constraints, the tracking of the position of the target or the generation of velocity instructions is achieved.

### Embodiment 4

Based on the above embodiments, the present disclosure further proposes a control guidance device for an aerial vehicle, the device including a memory, a processor, and a computer program stored in the memory and executable on the processor, the computer program implementing the steps of the control guidance method for an aerial vehicle as described in any one of the above items when executed by the processor.

It should be noted that the above device embodiment and the method embodiment belong to the same concept, and the specific implementation process thereof is detailed in the method embodiment, and the technical features in the method embodiment are applicable to the device embodiment accordingly, and will not be repeated here.

### Embodiment 5

Based on the above embodiments, the present disclosure further proposes a computer-readable storage medium, the computer-readable storage medium storing an aerial vehicle control guidance program, and the aerial vehicle control guidance program implementing the steps of the control guidance method for an aerial vehicle as described in any one of the above items when executed by the processor.

It should be noted that the above medium embodiment and the method embodiment belong to the same concept, and the specific implementation process thereof is detailed in the method embodiment, and the technical features in the method embodiment are applicable to the medium embodiment accordingly, and will not be repeated here.

It should be noted that, in this article, the terms “include”, “comprises” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “includes a . . . ” does not exclude the existence of other identical elements in the process, method, article or device including the element.

The serial numbers of the above embodiments of the present disclosure are only for description and do not represent the advantages and disadvantages of the embodiments.

Through the description of the above embodiments, those skilled in the art can clearly understand that the above embodiment method can be implemented by means of software plus the necessary general hardware platform, and of course by hardware, but in many cases the former is a better implementation method. Based on such an understanding, the technical solution of the present disclosure is essentially or the part that contributes to the prior art can be embodied in the form of a software product, which is stored in a storage medium (such as ROM/RAM, disk, optical disk), and includes several instructions for a terminal (which can be a mobile phone, computer, server, air conditioner, or network equipment, etc.) to execute the methods described in each embodiment of the present disclosure.

The embodiments of the present disclosure are described above in conjunction with the accompanying drawings, but the present disclosure is not limited to the above-mentioned specific implementation modes, which are merely illustrative rather than restrictive. Under the guidance of the present disclosure, ordinary technicians in this field can also make many forms without departing from the scope of protection of the present disclosure and the claims, all of which are within the protection of the present disclosure.

### INDUSTRIAL APPLICABILITY

The control guidance method, device and computer-readable storage medium of the aerial vehicle of the embodiment of the present disclosure calculate the horizontal acceleration target and the vertical acceleration target by inputting the three-dimensional velocity target, the three-dimensional velocity feedforward instruction and the three-dimensional velocity observation data into the velocity controller of the aerial vehicle; the horizontal acceleration target and the horizontal acceleration observation data are input into the horizontal acceleration controller of the aerial vehicle to calculate the horizontal attitude target, and the vertical acceleration target, the vertical acceleration observation data and the angle observation data are input into the vertical acceleration controller of the aerial vehicle to calculate the average rotational velocity; the horizontal attitude target, the angle observation data, the yaw angle target and the angular velocity observation data are input into the attitude controller of the aerial vehicle to calculate the three-axis rotational velocity difference, and the average rotational velocity and the three-axis rotational velocity difference are input into the power distribution module of the aerial vehicle to calculate the rotational velocity instructions of each motor of the aerial vehicle. The stable flight of the aerial vehicle and the execution of the guidance instruction are effectively realized, and the accuracy, stability and safety of the aerial vehicle flight control are greatly improved. Therefore, it has industrial applicability.

1. A control guidance method for an aerial vehicle, wherein the method comprises:
inputting a three-dimensional velocity target, a three-dimensional velocity feedforward instruction and three-dimensional velocity observation data into a velocity controller of the aerial vehicle, and calculating a horizontal acceleration target and a vertical acceleration target, wherein the three-dimensional velocity target is calculated by a position controller of the aerial vehicle according to a received three-dimensional position instruction and three-dimensional position observation data;
inputting the horizontal acceleration target and horizontal acceleration observation data into a horizontal acceleration controller of the aerial vehicle, and calculating a horizontal attitude target, and inputting the vertical acceleration target, vertical acceleration observation data and angle observation data into a vertical acceleration controller of the aerial vehicle, and calculating an average rotational velocity; and
inputting the horizontal attitude target, the angle observation data, a yaw angle target and an angular velocity observation data into an attitude controller of the aerial vehicle, and calculating a three-axis rotational velocity difference, and inputting the average rotational velocity and the three-axis rotational velocity difference into a power distribution module of the aerial vehicle, and calculating a rotational velocity instruction of each motor of the aerial vehicle.

2. The control guidance method for an aerial vehicle according to claim 1, wherein before inputting the three-dimensional velocity target, the three-dimensional velocity feedforward instruction and the three-dimensional velocity observation data into the velocity controller of the aerial vehicle, and calculating the horizontal acceleration target and the vertical acceleration target, comprises:
decoupling a position motion of the aerial vehicle into a horizontal channel and a vertical channel; and
decoupling a rotational motion of the aerial vehicle into a roll channel, a pitch channel and a yaw channel.

3. The control guidance method for an aerial vehicle according to claim 2, wherein decoupling the position motion of the aerial vehicle into the horizontal channel and the vertical channel comprises:
using height, vertical velocity and angle of the aerial vehicle as observation feedback of the vertical channel, and outputting the average rotational velocity of each propeller of the aerial vehicle; and
performing motion control of the aerial vehicle in a vertical direction by controlling a vertical component of an overall pulling force corresponding to the average rotational velocity.

4. The control guidance method for an aerial vehicle according to claim 2, wherein decoupling the position motion of the aerial vehicle into the horizontal channel and the vertical channel comprises:
using position and horizontal velocity of the aerial vehicle as observation feedback of the horizontal channel, outputting a target attitude angle of the aerial vehicle, and the attitude controller performing attitude control of the aerial vehicle by adjusting a rotational velocity difference of each propeller of the aerial vehicle; and
when an overall lift in a vertical direction is dynamically equal to the gravity of the aerial vehicle, horizontal acceleration control of the aerial vehicle is used as control of the horizontal channel.

5. The control guidance method for an aerial vehicle according to claim 2, wherein decoupling the rotational motion of the aerial vehicle into the roll channel, the pitch channel and the yaw channel comprises:
controlling rotational velocities of two propellers on a rotational motion axis of the aerial vehicle to form a preset rotational velocity difference; and
generating a rotational torque through the rotational velocity difference, and using control of the rotational torque as control of the roll channel and the pitch channel.

6. The control guidance method for an aerial vehicle according to claim 2, wherein decoupling the rotational motion of the aerial vehicle into the roll channel, the pitch channel and the yaw channel comprises:
forming a preset anti-torque by controlling rotational directions and rotational velocities of multiple propellers of the aerial vehicle; and
generating a torque difference of a yaw axis of the aerial vehicle through the anti-torque, and controlling the torque difference as control of the yaw channel.

7. The control guidance method for an aerial vehicle according to claim 1, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

8. The control guidance method for an aerial vehicle according to claim 1, wherein the method further comprises:
when executing a curved route guidance, based on three-dimensional position information of two or more orderly arranged flight mission target points and the three-dimensional velocity target, sequentially performing two-point cubic interpolation to form a curve; and
according to the curve, updating and tracking a three-dimensional position target instruction to execute a curved flight.

9. The control guidance method for an aerial vehicle according to claim 1, wherein the method further comprises:
when executing a velocity micro-control guidance, receiving an external velocity adjustment instruction; and
planning the three-dimensional velocity feedforward instruction and the three-dimensional position instruction according to the velocity adjustment instruction and restriction constraints a vertical motion process parameter and a horizontal motion process parameter.

10. A control guidance device for an aerial vehicle, comprising a memory, a processor and a computer program stored in the memory and executable on the processor, wherein the computer program implements steps of the control guidance method for an aerial vehicle according to claim 1 when executed by the processor.

11. A computer-readable storage medium having a control guidance program for an aerial vehicle stored thereon, wherein the control guidance program for the aerial vehicle implements steps of the control guidance method for an aerial vehicle according to claim 1 when executed by a processor.

12. The control guidance method for an aerial vehicle according to claim 2, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

13. The control guidance method for an aerial vehicle according to claim 3, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

14. The control guidance method for an aerial vehicle according to claim 4, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

15. The control guidance method for an aerial vehicle according to claim 5, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

16. The control guidance method for an aerial vehicle according to claim 6, wherein the method further comprises:
when executing a linear route guidance, calculating a unit time velocity vector according to a current position of the aerial vehicle, a target point position and the three-dimensional velocity target; and
initializing the three-dimensional position instruction to a current three-dimensional position of the aerial vehicle, and updating a position target instruction in a form of discrete integral according to the current three-dimensional position and the unit time velocity vector, until an instruction position of the position target instruction is the target point position.

17. The control guidance method for an aerial vehicle according to claim 2, wherein the method further comprises:
when executing a curved route guidance, based on three-dimensional position information of two or more orderly arranged flight mission target points and the three-dimensional velocity target, sequentially performing two-point cubic interpolation to form a curve; and
according to the curve, updating and tracking a three-dimensional position target instruction to execute a curved flight.

18. The control guidance method for an aerial vehicle according to claim 3, wherein the method further comprises:
when executing a curved route guidance, based on three-dimensional position information of two or more orderly arranged flight mission target points and the three-dimensional velocity target, sequentially performing two-point cubic interpolation to form a curve; and
according to the curve, updating and tracking a three-dimensional position target instruction to execute a curved flight.

19. The control guidance method for an aerial vehicle according to claim 2, wherein the method further comprises:
when executing a velocity micro-control guidance, receiving an external velocity adjustment instruction; and
planning the three-dimensional velocity feedforward instruction and the three-dimensional position instruction according to the velocity adjustment instruction and restriction constraints a vertical motion process parameter and a horizontal motion process parameter.

20. The control guidance method for an aerial vehicle according to claim 3, wherein the method further comprises:
when executing a velocity micro-control guidance, receiving an external velocity adjustment instruction; and
planning the three-dimensional velocity feedforward instruction and the three-dimensional position instruction according to the velocity adjustment instruction and restriction constraints a vertical motion process parameter and a horizontal motion process parameter.
